(19) United States
(12) Patent Application Publication
(10) Pub. No.: US 2016/0339392 A1
(43) Pub. Date: Nov. 24, 2016

(54) Integrated Composite Roll Film

(71) Applicant: KORTECH ENVIRONMENT EQUIPMENT CO., LTD., Shanghai (CN)

(72) Inventor: Jason Park, Shanghai (CN)

(21) Appl. No.: 14/438,967

(22) PCT Filed: Nov. 27, 2014
(86) PCT No.: PCT/CN2014/092349

§ 371 Date: Apr. 28, 2015

(30) Foreign Application Priority Data
Nov. 24, 2014 (CN) 201410682436.3

(51) Int. Cl. B01D 63/10; C02F 1/28; B01D 63/12; C02F 1/44

(52) U.S. Cl. CPC B01D 63/10; C02F 1/441; C02F 1/283; B01D 63/12; B01D 2313/13; B01D 2313/40

(57) ABSTRACT

An integrated composite roll film, which is installed in a film shell, includes a roll film including a diaphragm and a hollow central pipe winding the diaphragm; wherein a central pipe has a plurality of water inlet holes cut thereon; being filtered by the diaphragm, water enters into a central pipe cavity through the water inlet hole; an inner diameter of the central pipe is matched with a pipe diameter of the roll film shell; and a filter material is installed in the cavity of the central pipe. The integrated composite roll film reduces the volume of the whole machine, increases the water outlet amount and facilitates assembly and disassembly.

### CROSS REFERENCE OF RELATED APPLICATION

This is a U.S. National Stage under 35 U.S.C 371 of the International Application PCT/CN2014/092349, filed Nov. 27, 2014, which claims priority under 35 U.S.C. 119(a-d) to CN 201410682436.3, filed Nov. 24, 2014.

### BACKGROUND OF THE PRESENT INVENTION

1. Field of Invention

The present invention relates to a kind of water filter equipment and more specifically, to a kind of integrated composite roll film structure.

2. Description of Related Arts

With the rapid development of the national industrialization, water source pollution has become a major problem to be solved urgently by the State currently. The pursuit of a healthy life by the nationals is conflicting sharply with the increasing deterioration of living water. To solve the status quo of potable water, reverse osmosis pure water machine is popular with customers.

The structure of existing water purification equipment is: wind diaphragm one revolution after another on a central pipe and then install the central pipe in the film shell. The pipe diameter of the film shell is standard, unchanged in the industry. The central pipe is usually very small in inner diameter and has a plurality of water inlet holes cut thereon. Being filtered by diaphragm, water enters into the central pipe cavity through the water inlet hole. Being filtered by diaphragm, tap water is able to get rid of salts, heavy metals, etc. which is able to achieve no deodorizing, bacteria killing and regulating of the weak acidic PH value, etc. Therefore, usually after diaphragm filtering, active carbon filter cartridge or other filter materials are post-positioned to absorb organic substances, deodorize, kill bacteria and regulate the PH value into an alkalescent value. This is more advantageous to the health of water drinkers. This kind of whole machine structure with filter cartridge post-positioned will definitely result in large whole machine volume, high production cost and wasting of resources.

To prevent raw water from entering into the central pipe and polluting the pure water therein, a separating plate is provided in the central pipe to divide the central pipe into two parts. As the existing central pipe is very small in inner diameter and in a long and thin shape, the separating plate is provided at a location close to the middle of the central pipe to avoid the long and thin central pipe shaking and causing the inner diameter of the overall central pipe to be deformed inconsistently during hollow processing to the central pipe. In the two parts separated by the separating plate, one part has water inlet holes cut therein with the internal cavity serving as a pure water inlet cavity. The other part is not used. Such a structure results in less water inlet holes necessary on the central pipe and less water inlet amount and thus influences the filter water flow rate and water amount.

Besides, in the existing water purification equipment, when taking out the central pipe having diaphragm wound from the film shell for replace or repair, force has to be exerted from one end of the central pipe. As the central pipe and film shell are very tightly sealed between them, a high force has to be exerted to take it out. And due to limitation by the existing structure of the central pipe itself, it is unable to find an appropriate point at which force is able to be exerted when exerting force. It is very inconvenient even if tools are used for operation which is able to even cause damages that bring a lot of inconvenience to replace and repair.

### SUMMARY OF THE PRESENT INVENTION

In view of the above defects existing in conventional technology, the present invention provides an integrated composite roll film to reduce the volume of the whole machine and increase the water outlet amount.

To achieve the above goal, the present invention adopts the following technical scheme:

An integrated composite roll film installed in a roll film shell, comprises a roll film comprising diaphragm and a hollow central pipe on which the diaphragm is wound; wherein a central pipe has a plurality of water inlet holes cut thereon; being filtered by the diaphragm, water enters into a cavity of the central pipe through the water inlet hole; an inner diameter of the central pipe is matched with a pipe diameter of the roll film shell.

An integrated composite roll film installed in a roll film shell, comprises a roll film comprising a diaphragm and a hollow central pipe on which the diaphragm is wound; wherein a central pipe has a plurality of water inlet holes cut thereon; being filtered by the diaphragm, water enters into a cavity of the central pipe through the water inlet hole; a filter material is installed in the cavity of the central pipe.

An integrated composite roll film installed in a roll film shell, comprises a roll film comprising diaphragm and a hollow central pipe on which the diaphragm is wound; wherein a central pipe has a plurality of water inlet holes cut thereon; being filtered by the diaphragm, water enters into a cavity of the central pipe through the water inlet hole; an inner diameter of the central pipe is matched with a pipe diameter of the roll film shell; a filter material is installed in the cavity of the central pipe.

A proportion between the inner diameter of the central pipe and the pipe diameter of the roll film shell is (4.5:5)-(1:5).

The roll film has more than two connected rolls.

The central pipe comprises a central pipe shell part and a quick-connection pipe shell part connected in a sealed manner. The quick-connection pipe shell part is used to fix the composite roll film in the roll film shell. The central pipe shell part has filter material installed.

The filter material is active carbon filter cartridge or other material in a particle, powder condition.

The central pipe shell part has a tail wing provided at one end to facilitate assembly and disassembly of the integrated composite roll film and the roll film shell.

The filter material has a fixed structure or is in a scattered structure.

When the filter material is in a fixed structure, the central pipe shell part and the tail wing has a structure for matched installation with a filter cartridge shape.

The quick-connection pipe shell and the central pipe shell part are integrally manufactured, or the tail wing and central pipe shell part are integrally integrated or are independent respectively.

The tail wing part and the central pipe shell part are sealed through bonding, welding or a seal ring therebetween.

The central pipe shell part has a separating plate therein. The separating plate is provided close to the tail wing. The water inlet hole is provided on the central pipe shell part between the separating plate and the quick-connection pipe shell part.

The separating plate is located at 1/7 of the central pipe shell part.

The separating plate and the tail wing are integrally manufactured.

The central pipe shell part and the quick-connection pipe shell part and the tail wing part are sealed through bonding, welding or a seal ring among them.

The roll film comprises RO (reverse osmosis) film, ultrafiltration membrane.

In comparison with the existing technology, the present invention has the following beneficial effects:

1. The inner diameter of the central pipe increases. As a result, the process of the central pipe becomes easier and both processing speed and quality are improved.

2. By increasing the inner diameter of the central pipe, place the post-positioned active carbon filter cartridge or other filter materials in the whole machine using the existing technology in the central pipe cavity. As a result, the central pipe becomes the shell of the filter cartridge, the volume of the whole machine, the product cost and resources are saved.

3. The increase of the inner diameter of the central pipe enables the separating plate to be located somewhere close to the end of the central pipe. As a result, the water inlet cavity volume of the central pipe and the number of water inlet holes provided on the central pipe are increased for more pure water inlet amount.

4. At one end of the central pipe, a tail wing is added. In removing the central pipe, the central pipe is able to be removed conveniently by exerting force on the tail wing.

### BRIEF DESCRIPTION OF THE DRAWINGS

FIG. 1 is a structural schematic diagram of an integrated composite roll film installed in a film shell, which is provided by the present invention;

FIG. 2 is a C-C sectional view of FIG. 1;

FIG. 3 is a structural schematic diagram of a central pipe adopting conventional technology;

FIG. 4 is a structural schematic diagram of an embodiment of the central pipe provided by the present invention;

FIG. 5 is a front schematic diagram of a tail wing in FIG. 4;

FIG. 6 is a partial A-A sectional view in FIG. 4;

FIG. 7 is a partial sectional view of another embodiment of the central pipe provided by the present invention.

In the figures: 1. Quick-connection pipe shell part; 2. Seal; 3. Central pipe shell part; 4. Water inlet hole; 5. Pure water passageway; 6. Pure water outlet; 7. Separating plate; 8. Tail wing; 9. Rib; 10. Pure water inlet cavity; 11. Quick-connection inserting end; 12. Film shell; 13. RO (reverse osmosis) diaphragm; 14. Filter material; 15. Central pipe.

### DETAILED DESCRIPTION OF THE PREFERRED EMBODIMENT

The following describes in detail the technical scheme of the present invention in combination with specification figures and embodiments.

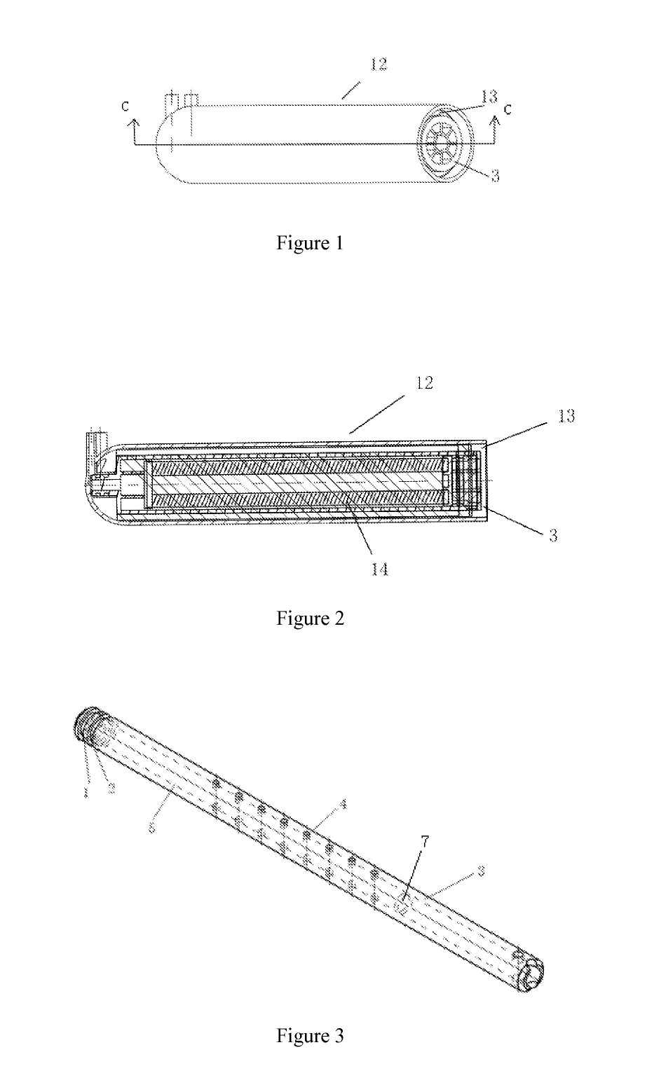

As shown in FIGS. 1 and 2, an integrated composite roll film provided by the present invention is installed in a standard film shell 12, comprising an RO (reverse osmosis) diaphragm 13, a hollow central pipe 15 on which the RO (reverse osmosis) diaphragm 13 is wound. The central pipe 15 has a plurality of water inlet holes 4 provided thereon. Being filtered by the RO (reverse osmosis) diaphragm 13, water enters into a pure water inlet cavity 10 of the central pipe 15 through the water inlet hole 4.

An inner diameter of the central pipe 15 is provided in a matched manner according to a pipe diameter of the roll film shell 12. In the pure water inlet cavity 10 of the central pipe 15, an active carbon filter cartridge 14 is installed.

The roll film constituted by the diaphragm and the hollow central pipe on which the diaphragm is wound is able to be more than two cascade structures.

The central pipe 15 comprises a central pipe shell part 3 and a tail wing part 8 at one end thereof. The two parts are sealed through bonding, welding or a seal ring therebetween. A filter material 14 is installed in the central pipe shell part 3. When the filter material 14 is an active carbon cartridge, the central pipe shell part 3 has a structure for matched installation with a shape of the active carbon filter cartridge at an end where the active carbon filter cartridge is installed, as shown in FIG. 3. When the filter material is in other particle, powder forms, just place it in the central pipe shell part 3.

What is shown in FIG. 3 is the central pipe structure adopting the conventional technology. The central pipe is long and thin, comprising the central pipe shell part 3 and a quick-connection pipe shell part 1 at one end thereof. The quick-connection pipe shell part 1 and the roll film shell 12 are sealed with an O-ring at the seal 2. The central pipe shell part 3 has a plurality of water inlet holes 4 provided thereon and an internal part of central pipe shell part 3 is a pure water passageway 5. As the central pipe is in a long and thin structure, the requirement for the processing process is high and a separating plate 7 must be provided close to a middle position of the central pipe to ensure the central pipe inner diameter to be uniform and consistent. This causes less water inlet holes 4 to be provided on the central pipe and less water inlet amount.

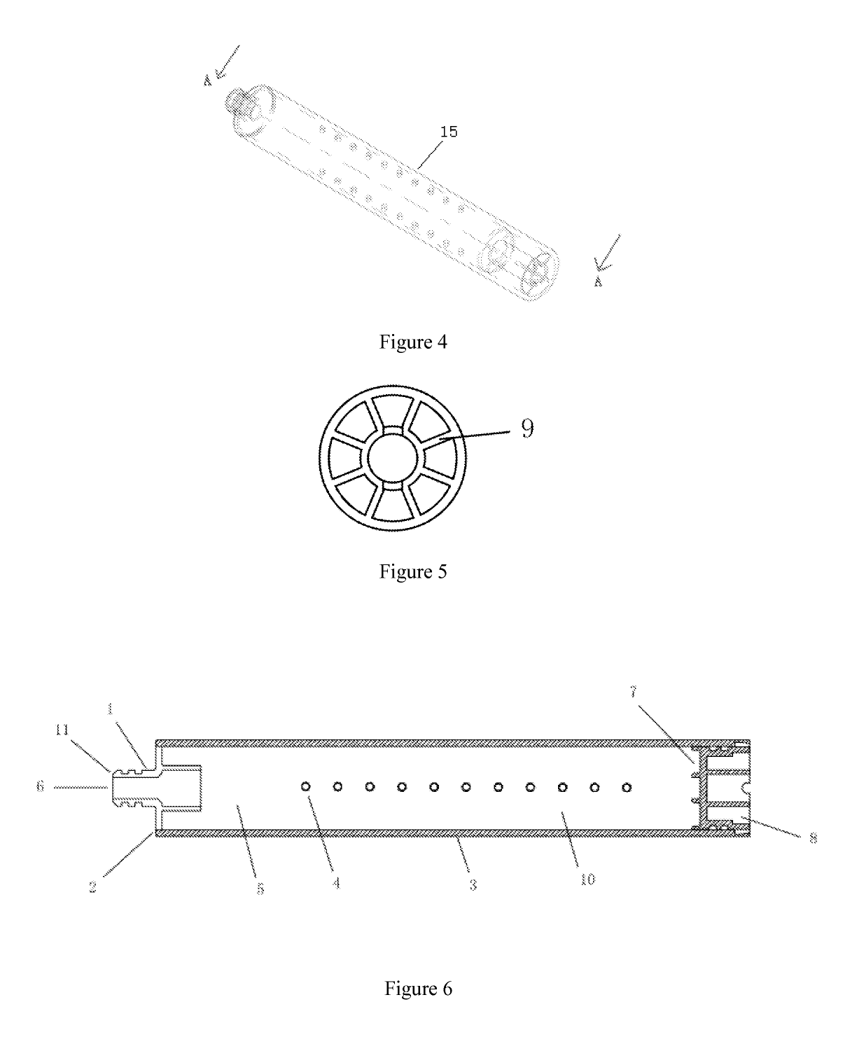

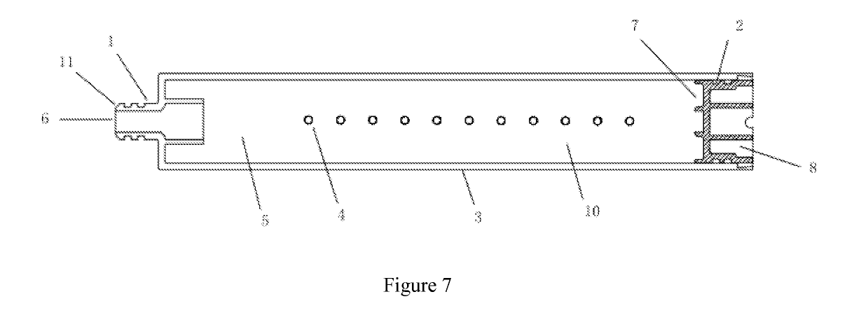

As shown in FIGS. 4-7, the inner diameter of the central pipe structure provided by the present invention is increased. Design is able to be made according to the inner diameter of the roll film shell 12. The proportion between the inner diameters of both is able to be set within a range of (4.5:5)-(1:5). When processing this kind of roughly designed central pipe, the requirement for processing process is not high. The separating plate 7 is able to be provided close to the tail wing. This structural design enables the number of water inlet holes 4 provided on the central pipe to increase resulting in more water inlet amount. In this embodiment, the separating plate 7 is able to be provided at 1/7 of the central pipe shell part 3. The water passageway will become larger for more pure water to pass through. The separating plate 7 is able to be independently provided and is able to also be integrally provided with tail wing 8.

In installation, the quick-connection pipe shell part 1 has the central pipe shell part 3 on which the RO (reverse osmosis) diaphragm 13 is wound installed by placing in the film shell 12 through a quick-connection inserting end 11 at one end thereof. When replacing active carbon in the central pipe or the RO (reverse osmosis) diaphragm outside the central pipe, exert force on the tail wing 8 to remove the central pipe shell part 3 on which RO (reverse osmosis) diaphragm is wound from the film shell. The tail wing 8 and the film shell are sealed between them. As the pure water passageway 5, the central pipe shell part 3 has the pure water inlet hole 4 and the pure water inlet 10 cavity thereon. After filtering, the pure water flows out from a pure water outlet 6 of the quick-connection pipe shell part 1.

In embodiment 1 of the present invention, when the filter material 14 installed in the central pipe shell is the active carbon filter cartridge or other specific materials in a fixed structure, the filter cartridge is installed at the end where the central pipe shell part connects with the tail wing part. When replacing the active carbon filter cartridge, just remove the tail wing and take out the filter cartridge from the film shell directly. At this point, the separating plate, and the tail wing are able to be integrally provided. And the central pipe shell part and the quick-connection pipe shell part are able to be integrally provided simultaneously. In embodiment 2 of the present invention, when replacing the active carbon filter cartridge, remove the quick-connection pipe shell part. At this point, the tail wing and the central pipe shell part are integrally provided. In embodiment 3 of the present invention, the quick-connection pipe shell part, the central pipe shell part and the tail wing are independent respectively. Provide combinational sealing on use. Put the filter material in the cavity of the central pipe shell part and then connect the quick-connection pipe shell part with the central pipe shell part for sealing. Next, connect the central pipe shell part and the tail wing part to seal again.

When the filter material 14 installed in the central pipe shell is in particle, powder or other non-fixed form, just install the filter material in the internal cavity of the central pipe shell part. When replacing the filter material, remove the tail wing, the separating plate and just take out the filter material from the film shell directly. At this point, the tail wing and the separating plate are able to be integrally provided, and the central pipe shell part and the quick-connection pipe shell part are able to be integrally provided simultaneously, or the tail wing part and the central pipe shell part and the quick-connection pipe shell part are able to be independent respectively.

The tail wing 8 is able to be provided in two concentric circle structures, between which a rib 9 is provided, as shown in FIG. 6. When it is necessary to take out the central pipe shell part 3 on which the RO (reverse osmosis) diaphragm 13 is wound from the film shell, using hands or tools to exert force on the rib 9 of the tail wing 8 is able to take it out conveniently.

The above embodiments are only used to describe the technical scheme of the present invention and not used to limit the present invention. Without divorcing from the scope and the spirit of the present invention, any technical people in this field are able to use the contents as revealed above to make all possible variations and modifications to the present invention. Therefore, all technical contents without divorcing from the present invention and any simple modification, equivalent change and decoration to the above embodiments based on the technical essence of the present invention belong to the protection scope of the present invention.

1-14. (canceled)

15. An integrated composite roll film installed in a roll film shell, comprising a roll film comprising a diaphragm and a hollow central pipe on which the diaphragm is wound; wherein a central pipe has a plurality of water inlet holes cut thereon; being filtered by the diaphragm, water enters into a cavity of the central pipe through the water inlet hole; an inner diameter of the central pipe is matched with a pipe diameter of the roll film shell.

16. An integrated composite roll film installed in a roll film shell, comprising a roll film comprising diaphragm and a hollow central pipe on which the diaphragm is wound; wherein a central pipe has a plurality of water inlet holes cut thereon; being filtered by the diaphragm, water enters into a cavity of the central pipe through the water inlet hole; a filter material is installed in the cavity of the central pipe.

17. An integrated composite roll film installed in a roll film shell, comprising a roll film comprising diaphragm and a hollow central pipe on which the diaphragm is wound; wherein a central pipe has a plurality of water inlet holes cut thereon; being filtered by the diaphragm, water enters into a cavity of the central pipe through the water inlet hole; an inner diameter of the central pipe is matched with a pipe diameter of the roll film shell; a filter material is installed in the cavity of the central pipe.

18. The integrated composite roll film, as recited in claim 15, wherein a proportion between the inner diameter of the central pipe and the pipe diameter of the roll film shell is (4.5:5)-(1:5).

19. The integrated composite roll film, as recited in claim 16, wherein a proportion between the inner diameter of the central pipe and the pipe diameter of the roll film shell is (4.5:5)-(1:5).

20. The integrated composite roll film, as recited in claim 17, wherein a proportion between the inner diameter of the central pipe and the pipe diameter of the roll film shell is (4.5:5)-(1:5).

21. The integrated composite roll film, as recited in claim 15, wherein the roll film has more than two connected rolls.

22. The integrated composite roll film, as recited in claim 16, wherein the roll film has more than two connected rolls.

23. The integrated composite roll film, as recited in claim 17, wherein the roll film has more than two connected rolls.

24. The integrated composite roll film, as recited in claim 15, wherein the central pipe comprises a quick-connection pipe shell part connected in a sealed manner in a proper order, a central pipe shell part and a tail wing, the quick-connection pipe shell part is used to fix the roll film in the roll film shell; and the central pipe shell part has filter material installed.

25. The integrated composite roll film, as recited in claim 16, wherein the central pipe comprises a quick-connection pipe shell part connected in a sealed manner in a proper order, a central pipe shell part and a tail wing, the quick-connection pipe shell part is used to fix the roll film in the roll film shell; and the central pipe shell part has filter material installed.

26. The integrated composite roll film, as recited in claim 17, wherein the central pipe comprises a quick-connection pipe shell part connected in a sealed manner in a proper order, a central pipe shell part and a tail wing, the quick-connection pipe shell part is used to fix the roll film in the roll film shell; and the central pipe shell part has filter material installed.

27. The integrated composite roll film, as recited in claim 26, wherein the central pipe shell part and the quick-connection pipe shell part, the tail wing and central pipe shell part are sealed through bonding, welding or a seal ring therebetween.

28. The integrated composite roll film, as recited in claim 26, wherein the filter material has a fixed structure or in a scattered structure.

29. The integrated composite roll film, as recited in claim 27, wherein the quick-connection pipe shell and the central pipe shell part are integrally manufactured, the filter material is removed from a tail wing end of the central pipe; or the tail wing and the central pipe shell part are integrally manufactured and the filter material is removed from a quick-connection pipe shell end of the central pipe.

30. The integrated composite roll film, as recited in claim 28, wherein the central pipe has a structure for matched installation with a shape of the filter material when the filter material is in a fixed structure.

31. The integrated composite roll film, as recited in claim 29, wherein the central pipe shell part has a separating plate therein, the separating plate is provided close to the tail wing, the water inlet hole is provided in the central pipe shell part between the separating plate and the quick-connection pipe shell part.

32. The integrated composite roll film, as recited in claim 31, wherein the separating plate is provided at a location of 1/7 of the central pipe shell part.

33. The integrated composite roll film, as recited in claim 31, wherein the separating plate and the tail wing are integrally manufactured.

34. The integrated composite roll film, as recited in claim 33, wherein the separating plate, the tail wing and the central pipe are integrally manufactured when the tail wing and the central pipe shell part are integrally manufactured.
